(19) United States
(12) Patent Application Publication
(10) Pub. No.: US 2008/0209626 A1
(43) Pub. Date: Sep. 4, 2008

(54) Fluid return jet fitting and face plate

(76) Inventor: Kristopher P. Thiel, Cape Coral, FL (US)

Correspondence Address: LITMAN LAW OFFICES, LTD., P.O. BOX 15035, CRYSTAL CITY STATION, ARLINGTON, VA, 22215, US

(21) Appl. No.: 11/712,468

(22) Filed: Mar. 1, 2007

(51) Int. Cl. A61H 33/00; E04H 4/00

(52) U.S. Cl. 4/507

(57) ABSTRACT

The fluid return jet fitting and face plate includes a removable face plate for covering the outwardly-facing or exposed surface of a fluid nozzle body flange, cap, eyeball fitting, or the like. The device includes a body portion for covering the flange or cap, and at least one pin projecting from a rear surface of the body portion that is movable into and out of alignment with a corresponding slot disposed on the flange or cap, the slot defining an opening therethrough to cause the face plate to be retained in, or released from, engagement with the flange. The face plates exposed surfaces have a decorative theme design, such as a glow-in-the-dark starfish, sea shell, sand dollar, turtle, or the like to coordinate with an aquatic environment as presented by a swimming pool, a wading pool, jacuzzi or the like.

### BACKGROUND OF THE INVENTION

1. Field of the Invention

The present invention relates generally to fluid nozzles, and particularly to a fluid return jet fitting and face plate for a return jet in a swimming pool, spa, jacuzzi or the like.

2. Description of the Related Art

Swimming pools, spas, jacuzzis, hot tubs, and the like require periodic cleaning to remove dirt and debris from the water and from the surface of the pool or tub. In order to reduce cleaning time and expense, many such pools and tubs are equipped with an automatic cleaning system that includes a system of suction drains for removing water from the upper portion of the pool for filtering and cleaning with return jets for pumping the water back in the pool. The return jets may be oriented to direct the circulation of the water towards the suction drains. The opening(s) or nozzle(s) in the return jet may be oriented to direct the return flow straight ahead, laterally or downward to increase the circulation of water below the level of the drains.

The return jets typically include a so-called eyeball fitting having a generally spherical or spheroid shape. The eyeball fitting may be a single opening or nozzle that can be swiveled to direct the flow of the return jet in the desired direction, or the eyeball fitting may have a plurality of nozzle openings directing flow as desired. The eyeball fitting is secured to a housing by a locking ring. The housing may be attached to the return pipe by a threaded fitting, by a “slip fitting” that forms an interference fit with the return pipe, or by other suitable coupling techniques.

While such return jets are effective in helping to keep the pool or tub clean, their appearance is often unattractive and detracts from the aesthetics of the pool or tub. There is a need for a decorative face plate or cover plate for improvement of this system.

Thus, a fluid return jet fitting and face plate solving the aforementioned problems is desired.

### SUMMARY OF THE INVENTION

The fluid return jet fitting and face plate include a removable face plate for covering the outwardly-facing or exposed surface of a fluid nozzle body flange, cap, eyeball fitting, or the like. The device includes a body portion for covering the flange or cap, and at least one pin projecting from a rear surface of the body portion that is movable into and out of alignment with at least one corresponding slot disposed on the flange or cap, the slot defining an opening therethrough, to cause the face plate to be retained in or released from engagement with the flange or cap. The face plate exposed surfaces have a decorative theme design, such as starfish, sea shell, sand dollar, turtle, and the like, to coordinate with an aquatic environment presented by a swimming pool, a wading pool, jacuzzi or the like.

These and other features of the present invention will become readily apparent upon further review of the following specification and drawings.

### BRIEF DESCRIPTION OF THE DRAWINGS

FIG. 1 is an environmental, perspective view of a fluid return jet fitting and face plate according to the present invention.

FIG. 2A is a side, perspective view of a threaded fluid return jet fitting and face plate according to the present invention.

FIG. 2B is an exploded, perspective view of the fluid return jet fitting and face plate of FIG. 2A.

FIG. 3 is a top view of the threaded cap of the threaded base return fitting of a fluid return jet fitting and face plate according to the present invention.

FIG. 4A is a side, perspective view of a slip fit fluid return jet fitting and face plate according to the present invention.

FIG. 4B: is an exploded, perspective view of the fluid return jet fitting and face plate of FIG. 4A.

FIG. 5 is a top view of the slip fit base return fitting of a slip fit fluid return jet fitting and face plate according to the present invention.

FIG. 6 is a side view in section of a face plate attached to a return fitting according to the present invention.

FIG. 7 is a perspective view of the sea shell face plate according to the present invention.

FIG. 8 is a perspective view of the star fish face plate according to the present invention.

FIG. 9 is a perspective view of the sand dollar face plate according to the present invention.

Similar reference characters denote corresponding features consistently throughout the attached drawings.

### DETAILED DESCRIPTION OF THE PREFERRED EMBODIMENT

The present invention is a fluid return jet fitting and face plate that includes a removable face plate for covering the outwardly-facing or exposed surface of a fluid nozzle body flange, cap, eyeball fitting, or the like. The device includes a body portion for covering the flange or cap, and at least one pin projecting from a rear surface of the body portion that is movable into and out of alignment with at least one corresponding slot disposed on the flange or cap, the slot defining an opening therethrough, to cause the face plate to be retained in, or released from, engagement with the flange or cap. The face plate and return fitting can be provided in an embodiment that includes a hollow threaded base return fitting, or, alternatively, in an embodiment that includes a hollow slip fit base return fitting.

The face plate exposed surfaces have decorative theme designs, such as starfish, sea shell, sand dollar, turtle, and the like, to coordinate with an aquatic environment as presented by a swimming pool, a wading pool, jacuzzi or the like. Additionally, the face plate may be made of a glow-in-the-dark thermoplastic or other material, or alternatively may be coated with a glow-in-the-dark coating. Moreover, the face plate may be made of thermoplastic or other material without glow-in-the-dark properties.

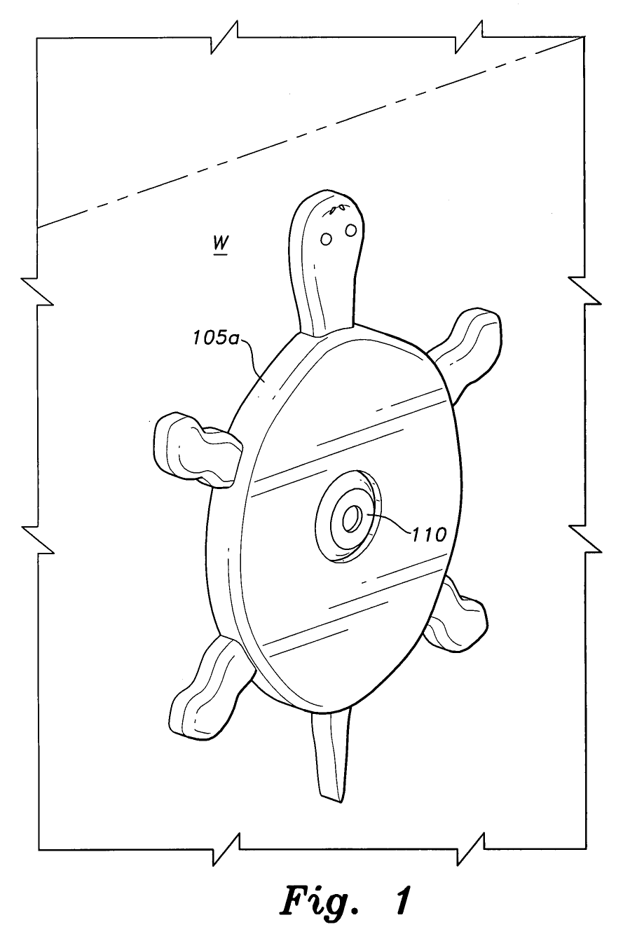

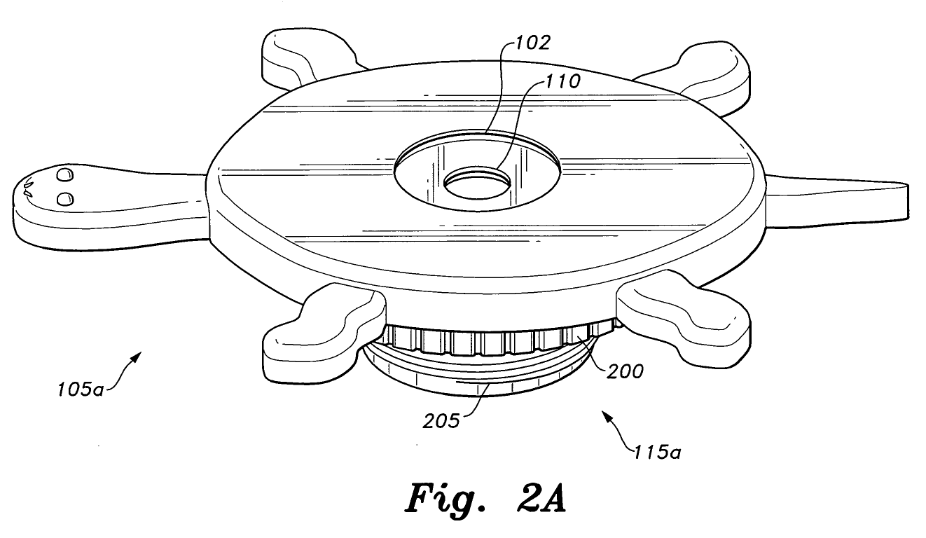

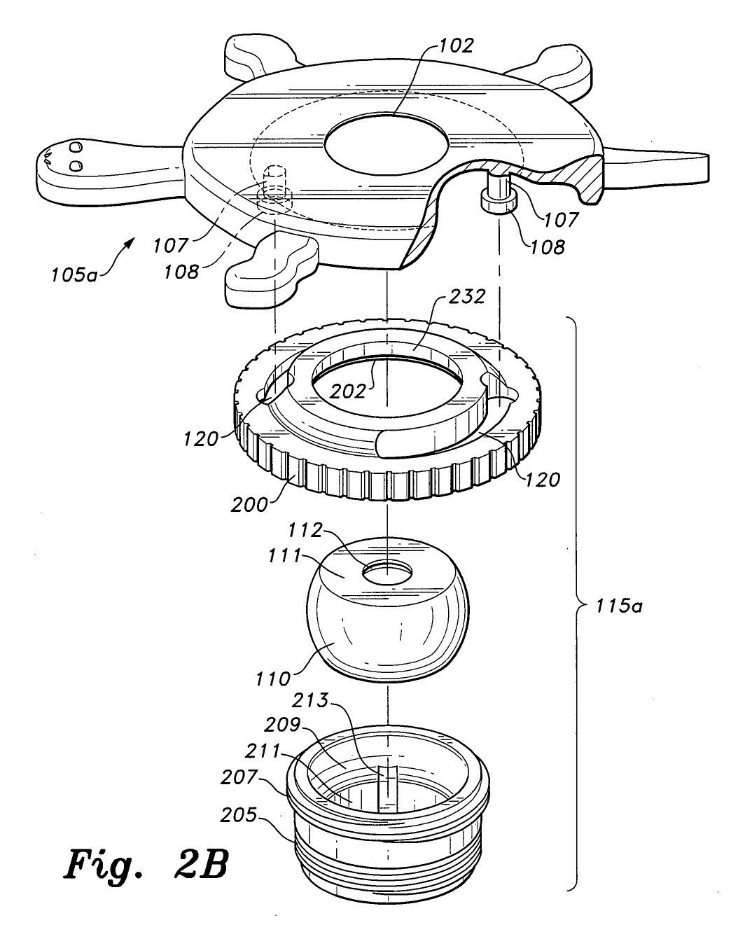

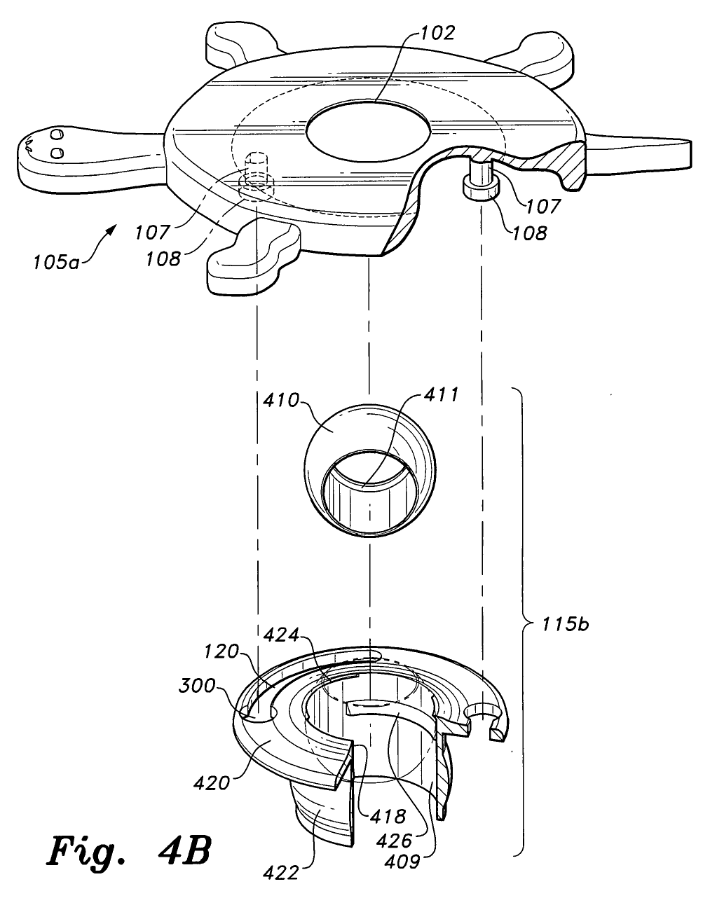

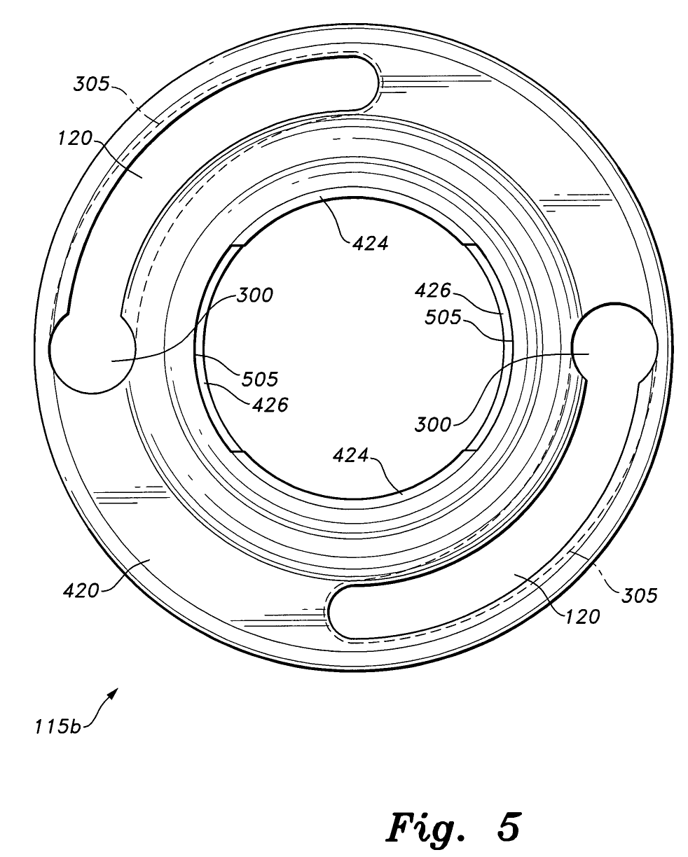

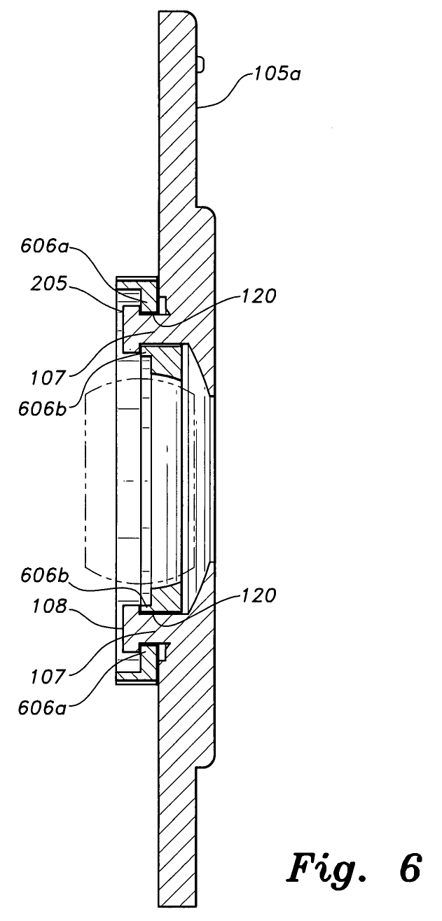

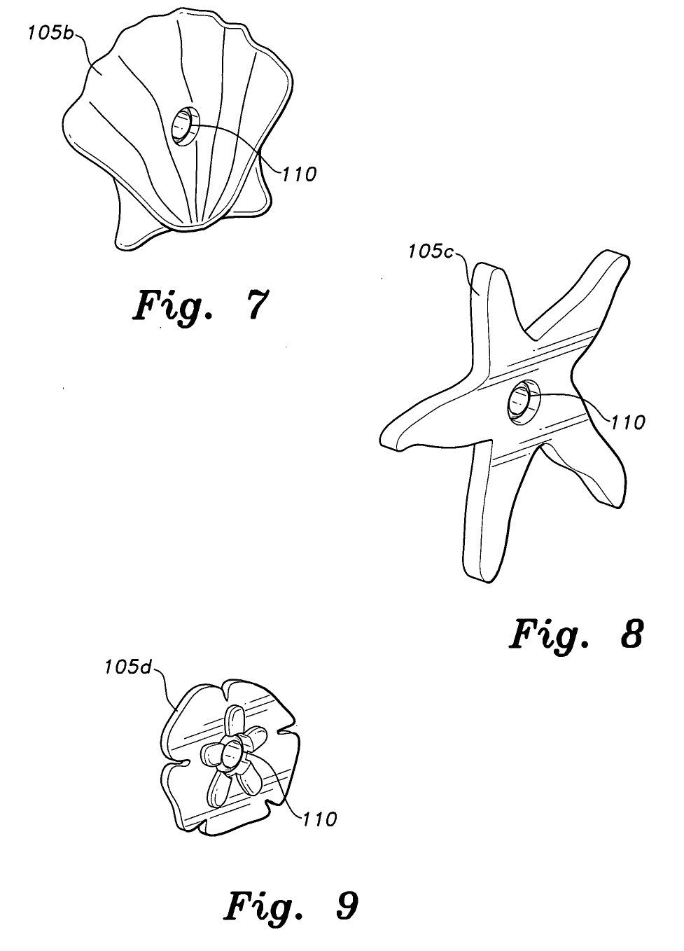

Referring to FIG. 1, a decorative turtle face plate 105a is attached to a return fitting that includes eyeball jet 110. The entire assembly is shown installed in a swimming pool sidewall W. As shown in FIG. 2A, face plate 105a is attached to the cap 200 of threaded base return fitting 115a. Threads 205 on the return base 115a can be used to thread into a return pipe in the wall W of a swimming pool. While the turtle face plate 105a is shown prominently in the figures, a sea shell face plate 105b, a starfish face plate 105c, or a sand dollar face plate 105d may also be provided, as shown in FIGS. 7 through 9, respectively. Moreover, it is contemplated by the present invention that a virtually limitless variety of other face plate designs may incorporate the features of the aforementioned face plates shown in FIGS. 1-9.

As particularly shown in FIG. 2B, the threaded base return fitting 115a is a pipe fitting having a cavity that can accommodate fluid flow into directional eyeball nozzle 110. A front section 111 of the directional eyeball nozzle 110 defines an aperture 112 through which fluid can flow in a desired direction. The hollow base fitting for the eyeball has an open frustospherical section 209 that extends into an open cylindrical section 211.

The frustospherical section 209 conforms to the generally spherical shape of eyeball 110, but is slightly larger in diameter at an opening proximate cap threads 207, while decreasing in diameter to form an opening smaller than the smallest diameter of the eyeball 110 near the interface of the frustospherical 209 and cylindrical sections 211 in order to support the eyeball 110 when inserted into the frustospherical section 209 of the threaded base unit 115a. Slotted tab 213 extends from the frustospherical section 209 into the cylindrical section 211 in order to guide proper placement of the eyeball 110 therein.

The eyeball is then retained by a cap 200, which has threads 202 complementary to threads 207 on the frustospherical section 209. The cap 200 is annular, having an aperture 232 through which directional eyeball 110 can extend and rotate to direct a stream of flowing water in a desired direction. A pair of generally arcuate slots 120 is disposed across opposing quadrants on the top of cap 200. The slots 120 are designed to engage pins 107 on the underside of face plate 105a for a secure attachment to cover the cap 200. As shown in FIGS. 2B, 3, and 6, the pins 107 have broad heads 108 that can pass through wide openings 300 of arcuate slots 120.

The arcuate slots 120 have a vertical taper 305 in combination with outer and inner retaining ledges 606a and 606b to form friction-fitted bayonet mounting receptacles for pin heads 108. The face plate 105a can then be rotated to lock the pins 107 into the slots 120, thereby forming a secure attachment of the face plate 105a to the base unit 115a. Aperture 102 on the face plate permits normal operations of the eyeball 110 in directing flow of fluid therethrough in a desired direction.

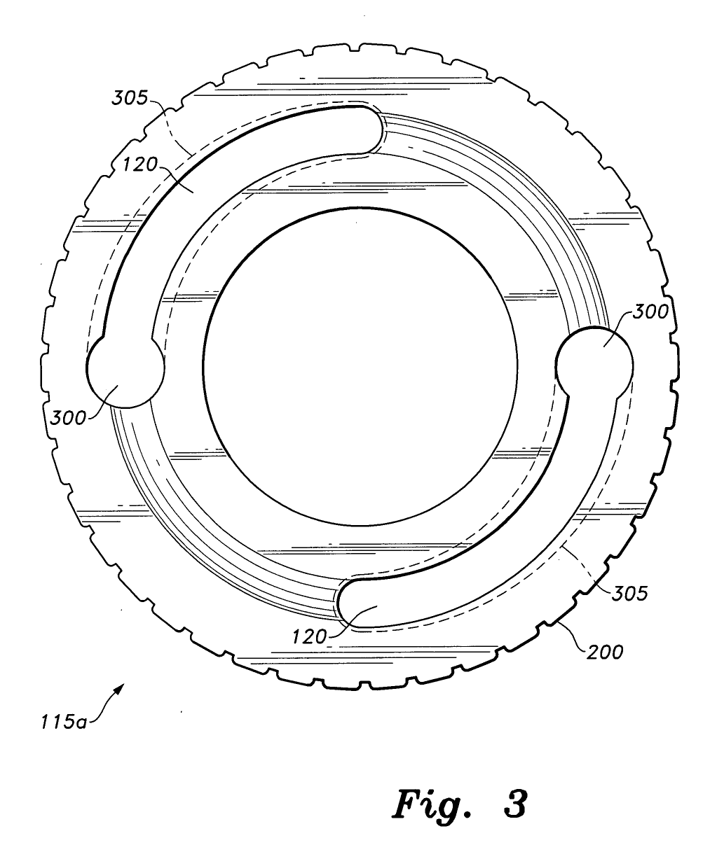

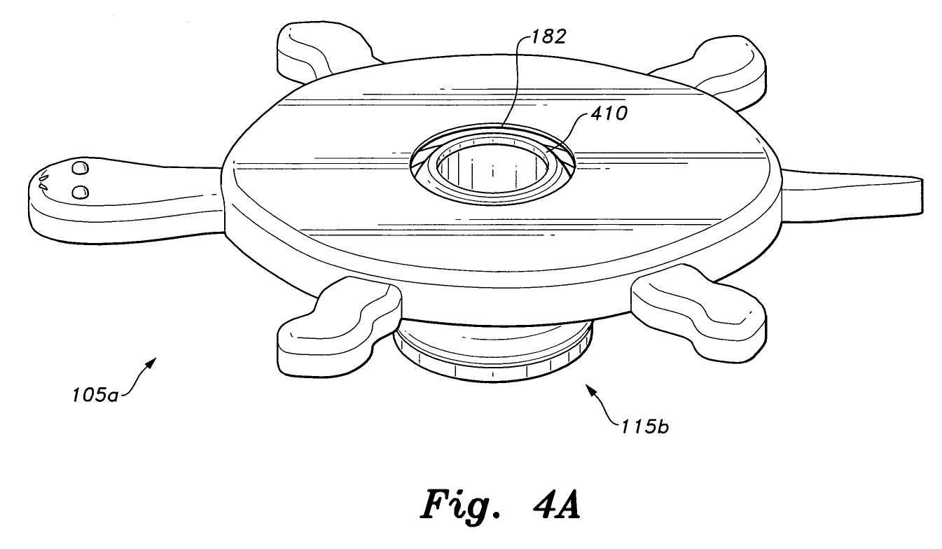

As shown in FIG. 4A, face plate 105a can be attached to a slip base return fitting 115b. As particularly shown in FIG. 4B, the slip base return fitting 115b is a pipe fitting having a substantially cylindrical cavity that can accommodate fluid flow into directional eyeball nozzle 410. A lip extending from the annular wall of directional eyeball 410 forms a front aperture 411 of the directional eyeball 410 through which fluid can flow in a desired direction. The fitting for the eyeball 410 has an open, substantially cylindrical section 418 and an annular flange 420 extending therefrom. As shown most clearly in FIG. 5, the flange 420 has a pair of eyeball-receiving recesses 505, which are capable of allowing the eyeball 410 to be inserted into the cavity of the cylindrical section 418.

Dimensions of the cylindrical section 418 conforms to the dimensions of annular-shaped eyeball 110. However, opposing wedge shaped flanges 426 are disposed on inner wall 409 of the cylindrical section 418 so that they extend down into the cavity in order to longitudinally constrain the eyeball 410 to an upper portion of the cylindrical section 418. The eyeball 410 is then retained in the fitting by rotating the eyeball 410 until it is in the orientation shown in dashed lines in FIG. 4B. From that position, the directional eyeball 410 can be rotated to direct a stream of flowing water in a desired direction. Eyeball retaining guides 424 extend inward from the flange 420 to assist in keeping the eyeball 410 engaged with the cylindrical section 418 as a user rotates the eyeball 410. An annular fitting boss 422 is disposed on the outside wall of the slip fitting cylindrical section 418 and is provided to form a slip friction fit inside of a fluid return pipe that may extend through a swimming pool wall, such as wall W shown in FIG. 1.

A pair of generally arcuate slots 120 is disposed across opposing quadrants on the top of the flange 420. The slots 120 are designed to engage pins 107 on the underside of face plate 105a for a secure attachment to cover the flange 420. As shown in FIGS. 4B, 5, and 6, the pins 107 have broad heads 108 that can pass through wide openings 300 of arcuate slots 120. The arcuate slots 120 have a vertical taper 305 in combination with outer and inner retaining ledges 606a and 606b to form friction-fitted bayonet mounting receptacles for pin heads 108. The face plate 105a can then be rotated to lock the pins 107 into the slots 120, thereby forming a secure attachment of the face plate 105a to the base unit 115b. Aperture 102 on the face plate permits normal operations of the eyeball 110 in directing flow of fluid therethrough in a desired direction.

It is to be understood that the present invention is not limited to the embodiment described above, but encompasses any and all embodiments within the scope of the following claims.

I claim:

1. A fluid return jet fitting and face plate, comprising:
an annular, threaded, eyeball-retaining cap having at least one arcuate slot defined therein;
a hollow base fitting having threads on a lower portion for threading onto a fluid return pipe, and threads on an upper portion to receive the threaded eyeball retaining cap;
a rotatable directional eyeball nozzle disposed inside of the threaded base fitting; and
a decorative cover plate having an aperture disposed therein to receive the directional eyeball nozzle, and at least one pin disposed on an underside thereof, the at least one pin removably engaging the at least one slot on the cap for attachment of the cover plate to the cap;
wherein when the threaded base fitting is assembled and connected to a return pipe through a wall, and the cover plate is engaged with the cap, the cover plate covers the cap and base fitting while permitting full functionality of the directional eyeball nozzle.

2. The fluid return jet fitting and face plate according to claim 1, wherein the at least one slot comprises a pair of generally arcuate slots disposed across opposing quadrants of the cap, the slots having wide openings for accepting the pins, the at least one pin comprising two pins, each of the pins having a broad head capable of passing through the wide opening of a respective one of the arcuate slots.

3. The fluid return jet fitting and face plate according to claim 1, wherein the face plate is in the shape of a starfish.

4. The fluid return jet fitting and face plate according to claim 1, wherein the face plate is in the shape of a sea shell.

5. The fluid return jet fitting and face plate according to claim 1, wherein the face plate is in the shape of a sand dollar.

6. The fluid return jet fitting and face plate according to claim 1, wherein the face plate is in the shape of a turtle.

7. The fluid return jet fitting and face plate according to claim 1, wherein an outwardly facing portion of the face plate emanates a visible glow that can be seen in the dark.

8. The fluid return jet fitting and face plate according to claim 1, wherein the face plate is made from a molded thermoplastic.

9. The fluid return jet fitting and face plate according to claim 1, wherein the at least one arcuate slot has a vertical taper in combination with an outer retaining ledge and an inner retaining ledge in order to form a friction-fitted bayonet mounting receptacle for the at least one pin.

10. A fluid return jet fitting and face plate, comprising:
a rotatable annular eyeball nozzle;
a hollow base fitting having a substantially cylindrical inside wall and a substantially cylindrical outside wall;
an annular fitting boss being disposed on the outside wall in order to form a slip friction fit attachment to a fluid return pipe, the base fitting having an annular flange surrounding an upper portion of the fitting, the annular flange having a pair of recesses allowing the eyeball to be inserted into a cavity created by the cylindrical inner wall of the hollow base fitting, the annular flange having at least one arcuate slot defined therein;
opposing wedge-shaped bosses disposed on the inner wall of the cylindrical base, the wedge-shaped bosses extending down into the cavity of the base in order to longitudinally constrain the eyeball to an upper portion of the base; and
a decorative cover plate having an aperture disposed therein to receive the directional eyeball nozzle and at least one pin disposed on an underside of the cover plate, the at least one pin removably engaging the at least one slot on the flange for attachment of the cover plate to the flange;
wherein when the base fitting is assembled and connected to a return pipe through a wall, and the cover plate is engaged with the flange, the cover plate covers the flange and base fitting while permitting full functionality of the directional eyeball nozzle.

11. The fluid return jet fitting and face plate according to claim 10, wherein the at least one slot comprises a pair of generally arcuate slots disposed across opposing quadrants of the flange, the slots having wide openings for accepting the pins, the at least one pin comprising two pins, each of the pins having a broad head capable of passing through the wide opening of a respective one of the arcuate slots.

12. The fluid return jet fitting and face plate according to claim 10, wherein the face plate is in the shape of a starfish.

13. The fluid return jet fitting and face plate according to claim 10, wherein the face plate is in the shape of a sea shell.

14. The fluid return jet fitting and face plate according to claim 10, wherein the face plate is in the shape of a sand dollar.

15. The fluid return jet fitting and face plate according to claim 10, wherein the face plate is in the shape of a turtle.

16. The fluid return jet fitting and face plate according to claim 10, wherein an outwardly facing portion of the face plate emanates a visible glow that can be seen in the dark.

17. The fluid return jet fitting and face plate according to claim 10, wherein the face plate is composed of a thermoplastic molding.

18. The fluid return jet fitting and face plate according to claim 10, wherein the at least one arcuate slot has a vertical taper in combination with an outer retaining ledge and an inner retaining ledge in order to form a friction-fitted bayonet mounting receptacle for the at least one pin.
